(19) United States
(12) Patent Application Publication
(10) Pub. No.: US 2024/0165865 A1
(43) Pub. Date: May 23, 2024

(54) METHOD FOR PRODUCING PLASTIC MOLDED ARTICLE AND PLASTIC MOLDED ARTICLE

(71) Applicant: TOYODA GOSEI CO., LTD., Kiyosu-shi (JP)

(72) Inventors: Shohei YAMAMOTO, Kiyosu-shi (JP); Hideto MAEDA, Kiyosu-shi (JP); Yasuhiro KANEMOTO, Kiyosu-shi (JP)

(21) Appl. No.: 18/494,918

(22) Filed: Oct. 26, 2023

(30) Foreign Application Priority Data
Nov. 18, 2022 (JP) 2022-185220
Feb. 6, 2023 (JP) 2023-015990

(51) Int. Cl. B29C 45/37

(52) U.S. Cl. CPC B29C 45/372; B29K 2105/26

(57) ABSTRACT

A method for producing a plastic molded article includes pulverizing, into a granular state, a waste material including a base made of a thermoplastic and a decorative layer provided on a surface of the base. The method also includes melting the pulverized granular waste material. The method further includes molding the plastic molded article by injecting the molten waste material into a cavity of a mold. The mold includes a molding surface that molds a decorative surface of the plastic molded article. The molding surface includes an uneven section for a texturing process.

### BACKGROUND

### 1. Field

The present disclosure relates to a method for producing a plastic molded article and a plastic molded article.

### 2. Description of Related Art

A method has been introduced to produce plastic molded articles by collecting waste materials such as automobile bumper covers and reusing them as raw materials. Specifically, waste material is pulverized to be made granular. Then, the pulverized granular waste material is mixed with a granular virgin material that is the same thermoplastic as that of a base forming a waste material. The mixture is supplied to an injection molding apparatus and is melted by a heater. A plastic molded article is molded by injecting the molten mixture into a cavity of a mold.

Since a waste material such as a bumper cover includes a coating film on the surface of the base, particles of the coating film are dispersed in the decorative surface of the plastic molded article molded by reusing the waste material. This may degrade the appearance of the plastic molded article.

In this regard, Japanese Laid-Open Patent Publication No. 6-312427 discloses a method for recycling plastic molded articles, in which pulverized waste material is enclosed in a fibrous sheet bag formed by a fiber sheet, and the fiber sheet bag is preheated. Subsequently, the fiber sheet bag is set inside a die and subjected to hot pressing process. In a recycled molded product thus obtained, the entire fiber sheet is impregnated with the waste material, which has been thermally softened by hot pressing, so that a fiber-reinforced plastic layer is formed on the surface of the product. As a result, the base made of the pulverized waste material is concealed by the fiber-reinforced plastic layer, so that the external pattern of the base is not exposed at all.

The recycling method disclosed in the above-described publication requires a fiber sheet bag, increasing the number of components and the number of processes. In addition, since the decorative surface of the recycled product is formed by the reinforced-fiber plastic layer, there is room for improvement in preserving deterioration of the appearance.

The above-described issue arises not only when recycling waste material with a coating film applied to the surface of a base, but also similarly occurs when recycling waste material that has decorative layers such as plating layers or vapor deposition layers applied to the surface of bases. Further, the issue arises when recycling a waste material that includes a molded body of thermoplastic colored with pigment.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method for producing a plastic molded article is provided. The method includes: pulverizing, into a granular state, a waste material including a base made of a thermoplastic and a decorative layer provided on a surface of the base; melting the pulverized granular waste material; and molding the plastic molded article by injecting the molten waste material into a cavity of a mold. The mold includes a molding surface that molds a decorative surface of the plastic molded article. The molding surface includes an uneven section for a texturing process.

In another general aspect, a method for producing a plastic molded article is provided. The method includes: pulverizing, into a granular state, a waste material including a molded body made of a thermoplastic colored with a pigment; mixing the pulverized granular waste material with a granular virgin material of a thermoplastic that is the same as that of the molded body, the virgin material exhibiting a color different from that of the waste material; melting a mixture of the pulverized granular waste material and the virgin material; and molding the plastic molded article by injecting the molten mixture into a cavity of a mold. The mold includes a molding surface that molds a decorative surface of the plastic molded article. The molding surface includes an uneven section for a texturing process.

In yet another general aspect, a plastic molded article includes a base material made of a thermoplastic, particles dispersed in the base material and exhibiting a color different from that of the base material, and a decorative surface on which uneven texturing is provided.

Other features and aspects will be apparent from the following detailed description, the drawings, and the claims.

### BRIEF DESCRIPTION OF THE DRAWINGS

FIG. 1 is an enlarged cross-sectional view of a plastic molded article according to an embodiment, mainly illustrating a decorative surface.

FIG. 2 is a flowchart showing a method for producing the plastic molded article shown in FIG. 1.

FIG. 3 is a cross-sectional view of a mold for molding the plastic molded article shown in FIG. 1.

FIG. 4 is an enlarged cross-sectional view showing part of FIG. 3.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

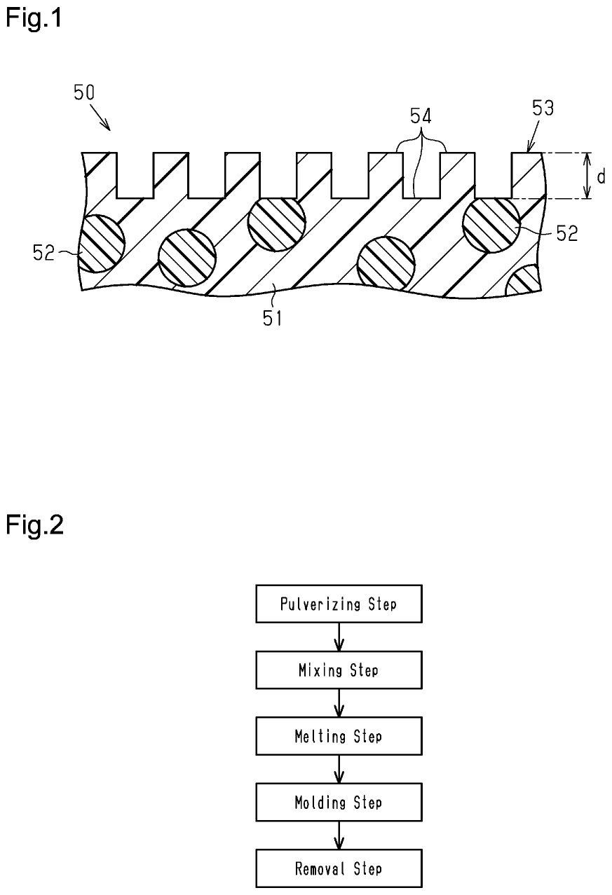

An embodiment will now be described with reference to FIGS. 1 to 4.

As shown in FIG. 1, a plastic molded article 50 includes a thermoplastic base material 51 and coating film particles 52 dispersed in the base material 51. The plastic molded article 50 is an exterior component such as a vehicle bumper cover.

The base material 51 is, for example, polypropylene. The coating film particles 52 are, for example, formed by pulverizing a coating film contained in waste material of a vehicle bumper cover. The coating film particles 52 exhibit a color different from that of the base material 51. The maximum diameter of the coating film particles 52 is, for example, 300 μm. The coating film of the present embodiment corresponds to an example of a decorative layer. The coating film particles 52 correspond to an example of particles.

The plastic molded article 50 includes a decorative surface 53 on which uneven texturing 54 is provided. In the plastic molded article 50 of the present embodiment, the texturing 54 is provided on the entire decorative surface 53. The decorative surface 53 of the plastic molded article 50 is formed by the base material 51 and the coating film particles 52. That is, the decorative surface 53 of the plastic molded article 50 is not provided with a coating film. FIG. 1 schematically show the shapes and sizes of the coating film particles 52 and the texturing 54.

Preferably, a depth d of the texturing 54 is in a range of 30 μm to 70 μm. Further preferably, the depth d of the texturing 54 is in a range of 40 μm to 60 μm. In the present embodiment, the depth d of the texturing 54 is 50 μm.

A method for producing the plastic molded article 50 will now be described with reference to FIG. 2.

As shown in FIG. 2, the method for producing the plastic molded article 50 includes a pulverizing step, a mixing step, a melting step, a molding step, and a removal step.

Pulverizing Step.

In the pulverizing step, a waste material (not shown) that includes a thermoplastic base and a coating film on the surface of the base is pulverized to be granular using a known pulverizer. The waste material is, for example, a vehicle bumper cover. In the present embodiment, the waste material is pulverized such that the maximum particle size is 300 μm. It is preferable to provide multiple crushing steps for reducing the size of the waste material in stages prior to the pulverizing step.

Mixing Step

The granular waste material (not shown), which has been pulverized in the pulverizing step is mixed with a granular virgin material (not shown) of a thermoplastic that is the same as that of the base.

Melting Step

In the melting step, the mixture of the virgin material and the waste material is introduced into a cylinder of a known injection molding apparatus. When a heater is energized to heat the mixture in the cylinder, the mixture is melted at a temperature higher than or equal to the melting point of the thermoplastic.

Molding Step

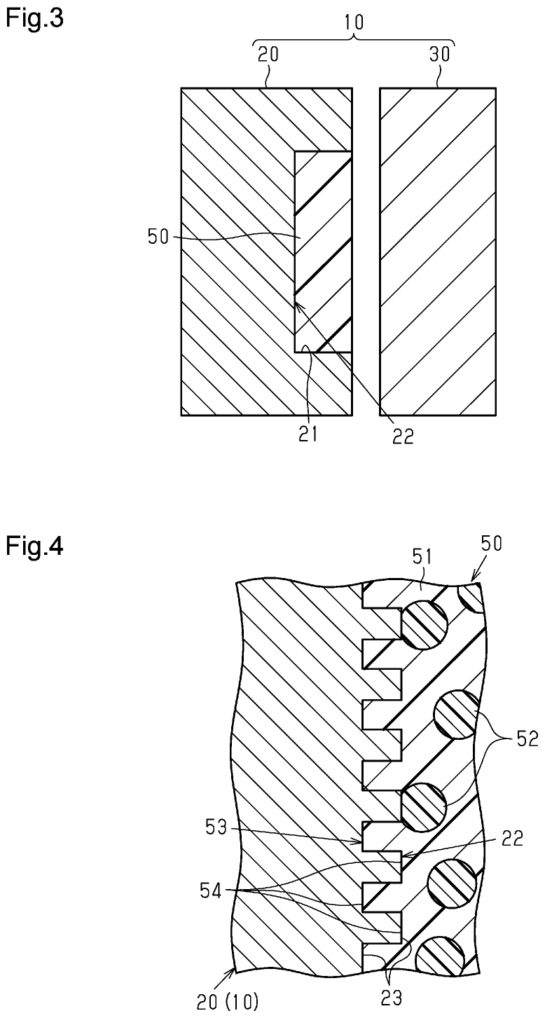

In the molding step, the mixture, which has been melted in the melting step, is injected from the cylinder into a cavity 21 of a mold 10 shown in FIG. 3 to form the plastic molded article 50. FIG. 3 shows a state in which the mold 10 is opened.

The mold 10 includes a first mold member 20 and a second mold member 30. The first mold member 20 includes a molding surface 22, which molds the decorative surface 53 of the plastic molded article 50.

The molding surface 22 includes an uneven section 23 for a texture process. Preferably, a depth of the uneven section 23 is set in a range of 30 μm to 70 μm. Further preferably, the depth of the uneven section 23 is in a range of 40 μm to 60 μm. In the present embodiment, the depth of the uneven section 23 is 50 μm.

Removal Step

In the removal step, the plastic molded article 50 is removed from the first mold member 20 by opening the mold 10 as shown in FIG. 3.

Operation of the present embodiment will now be described.

The plastic molded article 50 includes the decorative surface 53 on which the uneven texturing 54 is formed. This readily causes diffuse reflections on the decorative surface 53. Accordingly, the coating film particles 52 located in the vicinity of the surface of the plastic molded article 50 are unlikely to be visually recognized.

The present embodiment has the following advantages.

(1) The method for producing the plastic molded article 50 includes the pulverizing step, the melting step, and the molding step. The molding surface 22 of the mold 10 includes the uneven section 23 for a texturing process.

This method operates in the above-described manner and thus prevents deterioration of the appearance of the plastic molded article 50, while using a waste material with a coating film.

(2) The depth of the uneven section 23 is in the range of 30 μm to 70 μm.

If the depth d of the texturing 54 formed in the decorative surface 53 of the plastic molded article 50 is less than 30 μm, diffuse reflections are unlikely to occur on the decorative surface 53. Accordingly, the coating film particles 52 in the vicinity of the surface of the plastic molded article 50 are likely to be visually recognized. If the depth d of the texturing 54 exceeds 70 μm, the plastic molded article 50 cannot be smoothly removed from the mold 10. Furthermore, if the depth d of the texturing 54 exceeds 70 μm, the texturing 54 becomes more prone to accumulation of contaminants such as detergent and wax in the recesses of the texturing 54 during car washes.

In this regard, with the above-described method, the depth d of the texturing 54 formed on the decorative surface 53 of the plastic molded article 50 is in a range of 30 μm to 70 μm. This allows the plastic molded article 50 to be readily removed from the mold 10, while preventing the coating film particles 52 located in the vicinity of the surface of the plastic molded article 50 from being visually recognized. This also limits accumulation of contaminants in the recesses of the texturing 54.

(3) The method for producing the plastic molded article 50 includes the mixing step prior to the melting step. In the melting step, the mixture, which has been formed by mixing the waste material and the virgin material, is melted.

This method allows the ratio of waste material to the entire plastic molded article 50 to be reduced, thereby reducing the coating film particles 52 present in the vicinity of the surface of the plastic molded article 50. Thus, the coating film particles 52 are further difficult to visually recognize. This further effectively prevents deterioration of the appearance of the plastic molded article 50, while using a waste material with a coating film.

Further, with the above-described method, the plastic molded article 50 includes a virgin material. This increases the mechanical strength of the plastic molded article 50 as compared to a case in which the plastic molded article 50 is made only of a waste material.

Modifications

The above-described embodiment may be modified as follows. The above-described embodiment and the following modifications can be combined as long as the combined modifications remain technically consistent with each other.

The base material 51 is not limited to polypropylene, but may be another thermoplastic such as polyethylene terephthalate.

The maximum diameter of the coating film particles 52, that is, the maximum particle diameter in the pulverizing step, in which waste material is pulverized, may be less than 300 μm, such as 250 μm or 200 μm, or may be greater than 300 μm, such as 350 μm or 400 μm.

The plastic molded article 50 may be produced solely by a waste material.

The plastic molded article 50 is not limited to an exterior component such as a vehicle bumper cover, but and may be a vehicle interior component such as an instrument panel.

The texturing 54 may be omitted from part of the decorative surface 53 of the plastic molded article 50.

The depth of the uneven section 23, that is, the depth d of the texturing 54, may be less than 30 μm or greater than 70 μm.

The decorative layer of the present disclosure is not limited to a coating film, but may be, for example, a plating layer, a hot stamping layer, a film layer, a vapor deposition layer, or a print layer.

In the pulverizing step of the above-described embodiment, the waste material, which includes the base made of a thermoplastic and the decorative layer provided on the surface of the base, is pulverized to be granular. However, a waste material that includes a thermoplastic molded body colored with a pigment may be pulverized to be granular. In the mixing step in this case, the granular waste material that has been pulverized in the pulverizing step is mixed with a granular virgin material that is the same thermoplastic as that of the molded body, and exhibits a color different from that of the waste material. In this case, the melting step and the molding step are performed in the same manner as the above-described embodiment, and an uneven section for the texturing process may be formed on the molding surface of the mold, which molds the decorative surface of the plastic molded article. In this structure, the decorative surface of the molded plastic molded article includes uneven texturing. This allows diffuse reflections to readily occur in the decorative surface. As a result, the pigment present in the vicinity of the surface of the plastic molded article and contained in the waste material are unlikely to be visually recognized. This prevents deterioration of the appearance, while using a waste material.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A method for producing a plastic molded article, the method comprising:
pulverizing, into a granular state, a waste material including a base made of a thermoplastic and a decorative layer provided on a surface of the base;
melting the pulverized granular waste material; and
molding the plastic molded article by injecting the molten waste material into a cavity of a mold, wherein
the mold includes a molding surface that molds a decorative surface of the plastic molded article, and
the molding surface includes an uneven section for a texturing process.

2. The method for producing the plastic molded article according to claim 1, wherein the uneven section has a depth in a range of 30 μm to 70 μm.

3. The method for producing the plastic molded article according to claim 1, further comprising:
prior to the melting the pulverized granular waste material, mixing the pulverized granular waste material with a granular virgin material of a thermoplastic that is the same as that of the base, wherein
the melting the pulverized granular waste material includes melting a mixture of the waste material and the virgin material, and
the molding the plastic molded article includes molding the plastic molded article by injecting the molten mixture into the cavity of the mold.

4. A method for producing a plastic molded article, the method comprising:
pulverizing, into a granular state, a waste material including a molded body made of a thermoplastic colored with a pigment;
mixing the pulverized granular waste material with a granular virgin material of a thermoplastic that is the same as that of the molded body, the virgin material exhibiting a color different from that of the waste material;
melting a mixture of the pulverized granular waste material and the virgin material; and
molding the plastic molded article by injecting the molten mixture into a cavity of a mold, wherein
the mold includes a molding surface that molds a decorative surface of the plastic molded article, and
the molding surface includes an uneven section for a texturing process.

5. A plastic molded article, comprising:
a base material made of a thermoplastic;
particles dispersed in the base material and exhibiting a color different from that of the base material; and
a decorative surface on which uneven texturing is provided.

6. The plastic molded article according to claim 5, wherein the texturing has a depth in a range of 30 μm to 70 μm.
